(19) United States
(12) Patent Application Publication
(10) Pub. No.: US 2013/0088338 A1
(43) Pub. Date: Apr. 11, 2013

(54) APPARATUS AND METHOD FOR PROVIDING KEY SOUND EFFECTS IN A MOBILE TERMINAL

(71) Applicant: Samsung Electronics Co., Ltd., Gyeonggi-do (KR)

(72) Inventor: Hak-Sung LYOU, Gyeongsangbuk-do (KR)

(73) Assignee: SAMSUNG ELECTRONICS CO., LTD., Gyeonggi-do (KR)

(21) Appl. No.: 13/648,424

(22) Filed: Oct. 10, 2012

(30) Foreign Application Priority Data
Oct. 10, 2011 (KR) 10-2011-0103276

(51) Int. Cl. G08B 3/10

(52) U.S. Cl. 340/384.5

(57) ABSTRACT

In an apparatus and a method for providing a key sound effect in a mobile terminal, when one key is selected among a plurality of keys included in a key pad, a key sound effect corresponding to the selected key is detected among key effect sounds corresponding to the plurality of previously stored keys in a pulse code modulation (PCM) method and the detected key sound effect is output through a speaker without conversion.

### CLAIM OF PRIORITY

This application claims the priority under 35 U.S.C. §119(a) of an application entitled “Apparatus And Method For Providing Key Effect Sound In Mobile Terminal” filed in the Korean Intellectual Property Office on Oct. 10, 2011 and assigned Ser. No. 10-2011-0103276, the contents of which are hereby incorporated by reference.

### BACKGROUND OF THE INVENTION

1. Field of the Invention

The present invention relates to a mobile terminal, and more particularly, to an apparatus and a method for providing a key effect sound in a mobile terminal.

2. Description of the Related Art

Mobile terminals such as a smart phone and a tablet provide various useful functions to users through various applications.

In order to conveniently provide the various applications to the users, a mobile terminal operating system such as Android or Bada has been developed.

Such a mobile terminal operating system realizes an audio decoding function as software. In this type of audio decoding function, an effect sound for an input key is output after a passage of a predetermined time, for example, about 300 ms from when the key is input by the user. The delay in the slow sound output has a drawback when the user wishes to operate the key activation at a faster paste. That is, since the mobile terminal outputs a key input sound effect corresponding to the activation of an input key after passage of about 300 ms, it is not possible to immediately provide the key sound effect corresponding to the selected key to the user in the current scheme.
There is a need for a faster way to produce the key sound effect during the operation of a mobile terminal.

### SUMMARY OF THE INVENTION

Accordingly, an aspect of the present invention is to solve the above-mentioned problems occurring in the prior art, and to provide an apparatus and a method for immediately providing a key effect sound corresponding to a selected key when the key is selected by a user.

In accordance with an aspect of the present invention, there is provided an apparatus for providing a key sound effect in a mobile terminal, including a memory for previously storing a plurality of key sound effects corresponding to a plurality of keys included in a key pad according to a pulse code modulation (PCM) method, a controller for detecting a key sound effect corresponding to a selected key among the plurality of key effect sounds when the key is selected among the plurality of keys, and an audio processor for outputting the detected key sound effect through a speaker without conversion.

In accordance with another aspect of the present invention, there is provided a method of providing a key sound effect in a mobile terminal. When one key is selected among a plurality of keys included in a key pad, a key sound effect corresponding to the selected key is detected among key effect sounds corresponding to the plurality of previously stored keys according to a pulse code modulation (PCM) method and the detected key sound effect is output through a speaker without conversion.

According to the present invention, when the key is selected by the user, the key sound effect corresponding to the selected key is immediately provided.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of a mobile terminal according to an embodiment of the present invention;

FIG. 2 is a block diagram of an audio processor according to the embodiment of the present invention;

FIG. 3 is a block diagram of a memory according to the embodiment of the present invention; and

FIG. 4 is a flowchart illustrating processes of the mobile terminal according to the embodiment of the present invention providing a key effect sound.

### DETAILED DESCRIPTION

Hereinafter, exemplary embodiments of the present invention will be described with reference to the accompanying drawings. For the purposes of clarity and simplicity, a detailed description of known functions and configurations incorporated herein will be omitted as it may make the subject matter of the present invention rather unclear.

A mobile terminal according to an embodiment of the present invention corresponds to a movable electronic device that can be easily carried and may be a video telephone, a mobile telephone, a smart phone, an international mobile telecommunication (IMT) 2000 terminal, a wideband code division multiple access (WCDMA) terminal, a universal mobile telecommunication service (UMTS) terminal, a personal digital assistant (PDA), a portable multimedia player (PMP), a digital multimedia broadcasting (DMB) terminal, an E-book, a mobile computer (such as a notebook and a tablet) or a digital camera.

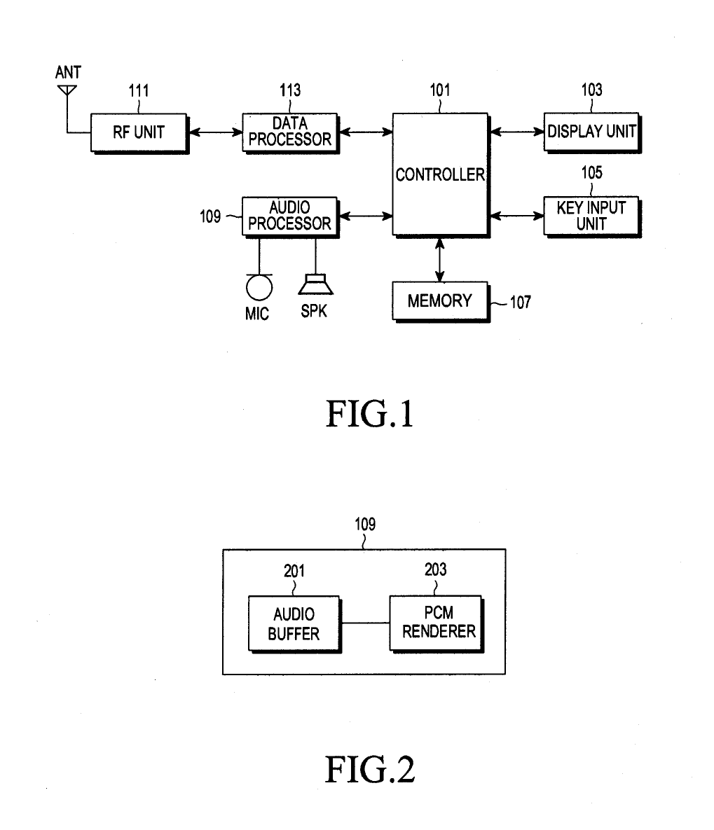

FIG. 1 is a block diagram of a mobile terminal according to an embodiment of the present invention.

Referring to FIG. 1, the mobile terminal includes a controller 101, a display unit 103, a key input unit 105, a memory 107, an audio processor 109, a radio frequency (RF) unit 111, and a data processor 113.

In operation, the RF unit 111 performs the radio communication function of the mobile terminal. In detail, the RF unit 111 includes a radio transmitter for up converting and amplifying the frequency of a transmitted signal and a radio receiver for low noise amplifying a received signal and down converting the frequency. The data processor 113 includes a transmitter for encoding and modulating the transmitted signal and a receiver for demodulating and decoding the received signal. The data processor 113 may include a modem.

The key input unit 105 includes keys for inputting number and character information items and functional keys for setting various functions. The display unit 103 displays an image signal on a screen and displays data requested to be output from the controller 101.

When the display unit 103 is realized by a touch display screen such as a capacitive touch screen or an impact touch screen, the key input unit 105 may include only previously set minimum keys, and the display unit 103 may partially replace the key input function of the key input unit 105. For example, the display unit 103 may display a key pad including a plurality of keys in accordance with the request of a user or the execution of a specific application.

The memory 107 includes a program memory and a data memory. The program memory stores a booting system and an operating system (hereinafter, referred to as OS) for controlling the common operation of the mobile terminal. The data memory stores various data items generated during the operation of the mobile terminal.

In particular, the memory 107 stores key effect sounds corresponding to a plurality of keys displayed on the display unit 103 or included in the key input unit 105 in a form of a look up table. At this time, the key effect sounds are stored in the form of audio data of a pulse code modulation (hereinafter, referred to as PCM) method. The audio data of the PCM method refers to data that may be reproduced without a decoding operation.

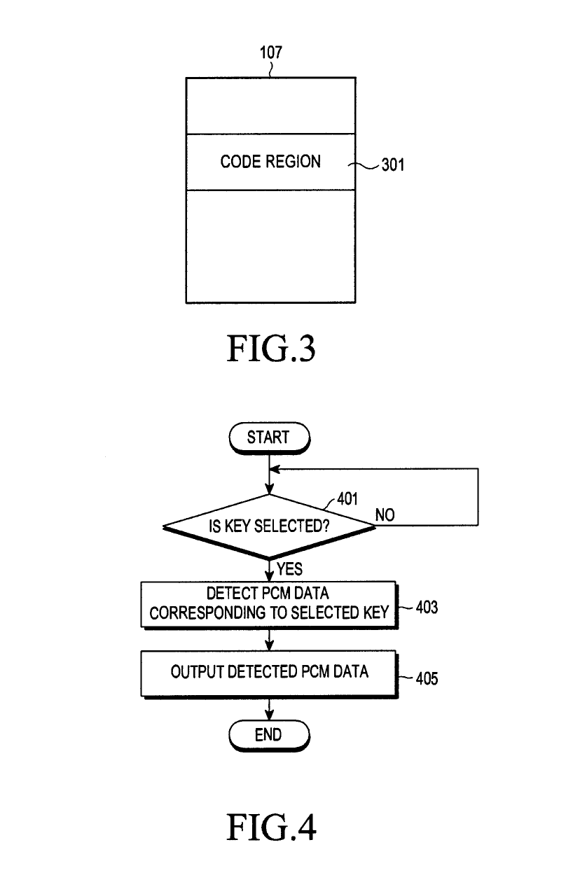

The memory 107 includes a code region 301, a data region, a stack region, and a heap region. In the code region 301, a code is stored, and data not to be deleted until a program is completed is stored in the data region. In the stack region, volatile data is stored. In the heap region, data desired by the user is stored. In particular, the key effect sounds may be stored in the specific region of the memory 107, for example, in the code region 301 of the memory 107, as illustrated in FIG. 3.

The controller 101 controls the overall operation of the mobile terminal. In particular, when one key is selected among the plurality of keys included in the key pad by the user, the controller 101 detects the PCM audio data corresponding to the selected key from the memory 107 and outputs the detected PCM audio data to the audio processor 109. More specifically, when the key effect sounds are stored in the code region 301 of the memory 107, the controller 101 may detect the PCM audio data corresponding to the selected key from the code region 301 of the memory 107.

The audio processor 109 reproduces the received audio signal output from the controller 101 through a speaker or transmits the transmitted audio signal generated by a mike to the controller 101. In particular, the audio processor 109 directly outputs the PCM audio data corresponding to the selected key output from the converter 101 through the speaker without conversion or decoding.

Referring to FIG. 2, the audio processor 109 includes an audio buffer 201 and a PCM renderer 203.

In operation, the audio buffer 201 receives the PCM audio data corresponding to the selected key from the controller 101 to temporarily store the received PCM audio data and outputs the stored PCM audio data to the PCM renderer 203. The PCM renderer 203 reproduces the PCM audio data input from the audio buffer 201 through a speaker without conversion to output the key sound effect corresponding to the selected key.

As described above, the key effect sounds are prestored in the code region 301 of the memory 107 so that the controller 101 may rapidly detect the key sound effect corresponding to the key selected by the user. The key effect sounds are stored in the form of the PCM audio so that the audio processor 109 may directly reproduce the key sound effect corresponding to the key selected by the user without any decoding operation. When the key is selected by the user using such a method, the mobile terminal may output the key sound effect corresponding to the selected key after about 50 ms.

FIG. 4 is a flowchart illustrating processes of the mobile terminal according to the embodiment of the present invention providing a key effect sound.

Before describing FIG. 4, it is assumed that the mobile terminal prestores the key effect sounds corresponding to the plurality of keys displayed on the display unit 103 or included in the key pad provided in the key input unit 105. It is assumed that the key effect sounds are stored in the code region 301 of the memory 107 in the form of the PCM audio data. In an alternate embodiment, the user may able to record different key effect sounds to different keys for a customized sound enjoyment.

Referring to FIG. 4, in step 401, the mobile terminal checks whether one of the keys is selected by the user from the key pad displayed on the display unit 103 or included in the key input unit 105. When a specific key is selected, the mobile terminal proceeds to step 403. When the specific key is not selected, the step 401 is repeatedly performed.

When the process proceeds to the step 403, the mobile terminal detects the PCM audio data corresponding to the selected key among the plurality of PCM audio data items corresponding to the plurality of previously stored keys, and the process proceeds to step 405.

In the step 405, the mobile terminal directly outputs the detected PCM audio data through the speaker without conversions to output the key sound effect corresponding to the selected key.

As described above, the key effect sounds are stored in the code region 301 of the memory 107 so that the mobile terminal may rapidly detect the key sound effect corresponding to the key selected by the user. The key effect sounds are prestored in the form of the PCM audio so that the mobile terminal may directly reproduce the key sound effect corresponding to the key selected by the user without any decoding operation. Thus, when the key is selected by the user according to the teachings of the present invention, the mobile terminal may output the key sound effect corresponding to the key selected much faster, about 50 ms.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof such as a mobile communication terminal, it will be understood by those skilled in the art that various changes in form and details may be made therein without departing from the spirit and scope of the invention as defined by the appended claims.

What is claimed is:

1. An apparatus for providing a key sound effect in a mobile terminal, comprising:
a memory for storing a plurality of key sound effects corresponding to a plurality of keys according to a pulse code modulation (PCM) method;
a controller for detecting at least one key input and the corresponding key sound effect; and
an audio processor for outputting the detected key sound effect through a speaker without any decoding operation.

2. The apparatus as claimed in claim 1, wherein the key sound effects are stored in a code region in the memory.

3. The apparatus as claimed in claim 1, wherein the audio processor comprises:
an audio buffer for temporarily storing the detected key sound effect; and
a PCM renderer for outputting the temporarily stored key sound effect through a speaker without any decoding operation.

4. A method of providing a key sound effect in a mobile terminal, comprising:
detecting an activation of an input key;
retrieving a key sound effect stored according to a pulse code modulation (PCM) method which corresponds to the activation of the input key; and
outputting the retrieved key sound effect through a speaker without any decoding operation.

5. The method as claimed in claim 4, wherein the key sound effect is stored in a code region of a memory.

6. The method as claimed in claim 4, wherein outputting of the retrieved key sound effect comprises:
temporarily storing the retrieved key sound effect; and
outputting the temporarily stored key sound effect through a speaker without any decoding operation.

7. The method as claimed in claim 4, further comprising storing a plurality of key sound effects corresponding to a plurality of keys according to a pulse code modulation (PCM) method.

8. A method of providing a key sound effect in a mobile terminal, comprising:
storing a plurality of key sound effects corresponding to a plurality of keys according to a pulse code modulation (PCM) method;
detecting an activation of an input key;
retrieving a key sound effect corresponding to the detected input key; and
outputting the retrieved key sound effect through a speaker without any decoding operation.

9. The method as claimed in claim 8, wherein the plurality of key sound effects is stored in a code region of a memory.

10. The method as claimed in claim 8, wherein outputting of the retrieved key sound effect comprises:
temporarily storing the retrieved key sound effect; and
outputting the temporarily stored key sound effect through a speaker without any decoding operation.
